(19) United States
(12) Patent Application Publication
(10) Pub. No.: US 2026/0089372 A1
(43) Pub. Date: Mar. 26, 2026

(54) IMAGING DEVICE, IMAGING SYSTEM, AND METHOD FOR OPERATING THE IMAGING SYSTEM

(71) Applicant: SK hynix Inc., Icheon-si (KR)

(72) Inventor: Jae Hyung JANG, Icheon-si (KR)

(21) Appl. No.: 19/034,363

(22) Filed: Jan. 22, 2025

(30) Foreign Application Priority Data
Sep. 26, 2024 (KR) 10-2024-0130582

(51) Int. Cl. H04N 23/52; H04N 23/21; H04N 23/57; H04N 23/65; H04N 23/69

(52) U.S. Cl. CPC H04N 23/52; H04N 23/21; H04N 23/57; H04N 23/65; H04N 23/69

(57) ABSTRACT

An imaging system is provided to include: a host device comprising a first imaging device; and an attachable device provided to be attachable to or detachable from the host device and comprising a second imaging device, wherein the attachable device further comprises: a first chip comprising a second image sensing device of the second imaging device; and a sensor configured to sense an attachment and a detachment of the attachable device with respect to the host device.

### CROSS-REFERENCE TO RELATED APPLICATION(S)

This patent document claims priority to Korea Patent Application No. 10-2024-0130582, filed Sep. 26, 2024, the entire contents of which is incorporated herein for all purposes by this reference.

### TECHNICAL FIELD

The present disclosure relates to an imaging device, an imaging system, and a method for operating the imaging system.

### BACKGROUND

Recently, with the development of information and communication technologies and the digitalization of image information, electrical devices, such as a digital camera, a camcorder, a mobile phone, a personal communication system (PCS), a game machine, security camera and a medical micro camera, are now equipped with image sensors having the improved performance. In general, the image sensor may include a pixel region which includes a photodiode and a peripheral circuit region. A unit pixel may include a photodiode and a transfer transistor. The transfer transistor may be disposed between the photodiode and a floating diffusion region and may transfer charges generated by the photodiode to the floating diffusion region.

### SUMMARY

Various implementations of the disclosed technology provide an imaging device capable of enabling interwork between a host device and an attach-type imaging device (or a second imaging device).

Some implementations of the disclosed technology provide a method for operating an imaging system with respect to the interwork between a host device and an attach-type imaging device (or a second imaging device).

Various technical advantages can be achieved by the present disclosure, which are not limited to the aforementioned ones and further include ones inferred from the following embodiments.

In one aspect, an imaging system is provided to include: a host device comprising a first imaging device; and an attachable device provided to be attachable to or detachable from the host device and comprising a second imaging device, wherein the attachable device further comprises: a first chip comprising a second image sensing device of the second imaging device; and a sensor configured to sense an attachment and a detachment of the attachable device with respect to the host device.

In another aspect, a method for operating an imaging system is provided. The method includes: detecting of an attachment of an attachable device comprising a second imaging device to a host device comprising a first imaging device; in response to the detecting of the attachment of the attachable device to the host device, allowing a second power supply of the attachable device to receive a turn-on signal and allowing the second power supply to turn on a second main processor of the attachable device; and operating at least one of the first imaging device or the second imaging device based on a magnification for capturing an image.

In another aspect, a method for operating an imaging system is provided. The method includes detecting of an attachment of an attachable device comprising a second imaging device to a host device comprising a first imaging device; and capturing an image using both of the first imaging device and the second imaging device, wherein the first imaging device comprises a first image sensing device configured to receive visible light, and wherein the second imaging device comprises a light emitting unit configured to emit a near-infrared light, and a second image sensing device configured to receive reflected light which is the near-infrared light emitted from the light emitting unit and reflected from an object.

Other details of the embodiments are included in the detailed description and the accompanying drawings.

According to the embodiments, it is possible to sense attachment of the second imaging device to the host device because the second imaging device includes a hall sensor.

According to the embodiments, use of the second imaging device alone is limited because power of the second imaging device is turned on according to attachment and detachment of the second imaging device from the host device. Therefore, there is an effect of protecting privacy.

According to the embodiments, at an increased magnification, it is possible to generate high resolution images because the attached second imaging device generates images.

According to the embodiments, at a decreased magnification, it is possible to generate an image of a wider angle of view because the attached second imaging device and the first imaging device of the host device can generate images at the same time.

According to the embodiments, a manner of supplying power may be diversified because the second imaging device attached to the host device is supplied with power from the host device.

According to the embodiments, the second imaging device may include a light emitting unit configured to emit infrared light to an object, and an image sensor configured to receive the reflected infrared light emitted by the light emitting unit. There is an effect that three-dimensional images can be generated by the second imaging device attached to the host device, and two-dimensional images can be generated by the first imaging device, thereby high-resolution three-dimensional synthetic images can be generated.

Those skilled in the art would appreciate that various implementations of the disclosed technology achieve the above-described effects and other effects which are not described but inferred from the following description of the embodiments.

### BRIEF DESCRIPTION OF THE DRAWINGS

FIG. 1 is a diagram illustrating an example of an imaging system based on some implementations of the disclosed technology.

FIG. 2 is a diagram illustrating an example of an attached device in FIG. 1 based on some implementations of the disclosed technology.

FIG. 3 is a diagram illustrating an example of a host device in FIG. 1 based on some implementations of the disclosed technology.

FIG. 4 is a diagram illustrating an example of a second imaging device in FIG. 2 based on some implementations of the disclosed technology.

FIG. 5 is a perspective view of an example of an attached device based on some implementations of the disclosed technology.

FIG. 6 is a perspective view of an example of an attached device based on some implementations of the disclosed technology.

FIG. 7 is a flowchart illustrating an example of a method for operating an imaging device based on some implementations of the disclosed technology.

FIG. 8 is a view illustrating an example in which a high magnification is applied to a photography application of a host device based on some implementations of the disclosed technology.

FIG. 9 is a diagram illustrating an example of an operation of a second imaging device when a high magnification is applied based on some implementations of the disclosed technology.

FIG. 10 is a view illustrating an example in which a low magnification is applied to a photography application of a host device based on some implementations of the disclosed technology.

FIG. 11 is a view illustrating angles of view of a first imaging device and a second imaging device when a low magnification is applied based on some implementations of the disclosed technology.

FIG. 12 is a diagram illustrating a course for processing an image generated by a first imaging sensing device and an image generated by a second image sensing device of an imaging system based on some implementations of the disclosed technology.

FIG. 13 is a diagram illustrating a course for processing an image generated by a first imaging sensing device and an image generated by a second image sensing device of an imaging system based on some implementations of the disclosed technology.

FIG. 14 is a diagram illustrating supply of power between a host device and an attached device of an imaging system based on some implementations of the disclosed technology.

FIG. 15 is a diagram illustrating supply of power between a host device and an attached device of an imaging system based on some implementations of the disclosed technology.

FIG. 16 is a block diagram illustrating an example of an imaging system based on some implementations of the disclosed technology.

FIG. 17 is a diagram illustrating an example an attached device in FIG. based on some implementations of the disclosed technology.

### DETAILED DESCRIPTION

Example embodiments will now be described with reference to the accompanying drawings.

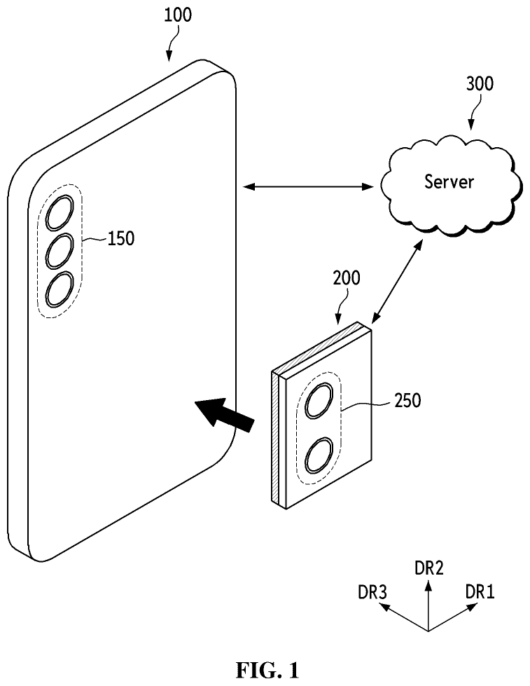

FIG. 1 is a diagram illustrating an imaging system according to an embodiment.

Referring to FIG. 1, an imaging system according to an embodiment may include a host device 100, an attachable device 200, and a server 300. The host device 100 may include a first image sensing device 150. The first image sensing device 150 may be provided in plural numbers, however, the embodiments of the present disclosure are not limited thereto. The attachable device 200 may include a second image sensing device 250. The second image sensing device 250 may be provided in plural numbers, however, the embodiments of the present disclosure are not limited thereto.

The attachable device 200 may be provided as being attachable or detachable from the host device 100. The attachable device 200 may be attached to a rear surface of the host device 100. When the attachable device 200 is attached to the rear surface of the host device 100, the attachable device 200 and the first image sensing device 150 may be disposed such that the attachable device 200 and the first image sensing device 150 do not interfere with each other.

The imaging system according to an embodiment may further include a server 300 capable of interworking with the host device 100 and the attachable device 200. In the example, the host device 100 may be implemented as a mobile phone, in particular, a smartphone, but is not limited thereto. A first imaging device including the first image sensing device 150 may be implemented as a DSLR (Digital Single Lens Reflex), a mirrorless camera, or others. The first imaging device can be implemented in various manners without being limited thereto. A second imaging device including the second image sensing device 250 may be implemented as a DSLR (Digital Single Lens Reflex), or a mirrorless camera, but is not limited thereto.

The first imaging device and the second imaging device may be of a concept of including a device capable of photographing an object and generating an image because the both include a lens and an imaging element, respectively.

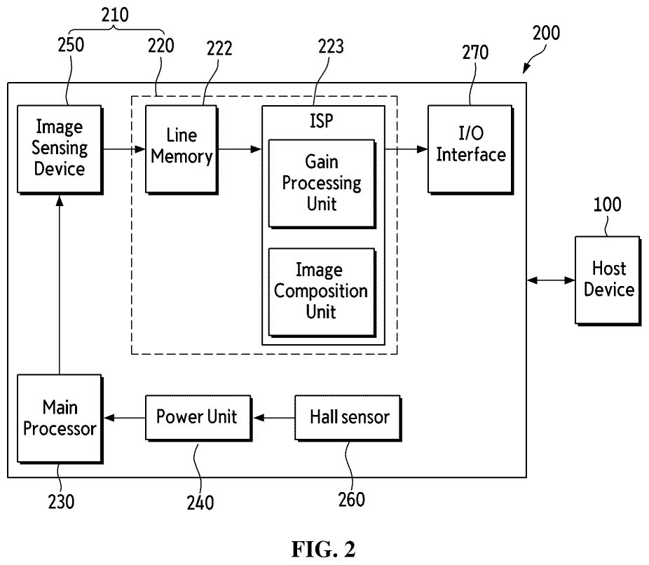

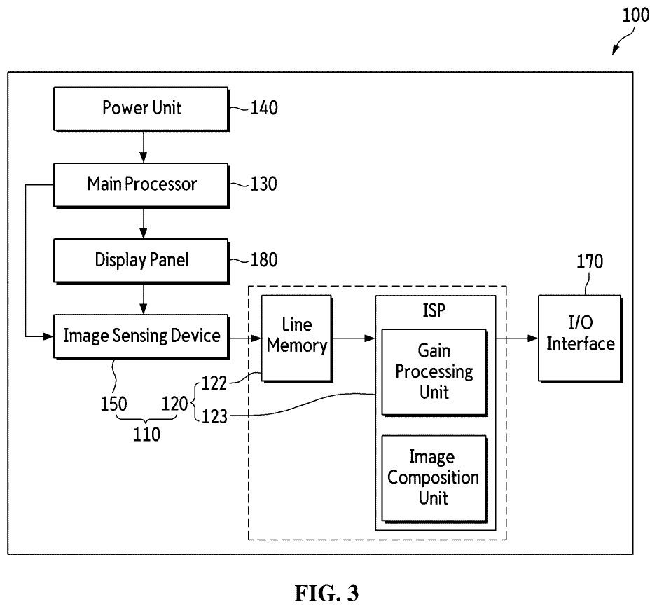

FIG. 2 is a diagram illustrating the attachable device in FIG. 1 based on some implementations of the disclosed technology. FIG. 3 is a diagram illustrating the host device in FIG. 1 based on some implementations of the disclosed technology.

Referring to FIGS. 2 and 3, the attachable device 200 may include a second imaging device 210, a main processor, a power unit, a hall sensor 260, and an I/O interface. The second imaging device 210 may include an image sensing device, a line memory, and an ISP (Image Signal Processor). Hereinafter, the main processor of the attachable device 200 will be referred to as a second main processor 230, the power unit of the attachable device 200 will be referred to as a second power unit 240, the I/O interface of the attachable device will be referred to as a second I/O interface 270, the image sensing device of the attachable device 200 will be referred to as the second imaging device 210, the line memory of the attachable device 200 will be referred to as a second line memory 222, and the ISP of the attachable device 200 will be referred to as a second ISP 223. The second line memory 222 and the second ISP 223 illustrated in FIG. 2 will be referred to as a second logic unit 220.

The host device 100 may include a first imaging device 110, a display panel 180, a main processor, a power unit, and an I/O interface. The first imaging device 110 may include an image sensing device, a line memory, and an ISP (Image Signal Processor). Hereinafter, the main processor of the host device 100 will be referred to as a first main processor 130, the power unit of the host device 100 will be referred to as a first power unit 140, the I/O interface of the host device 100 will be referred to as a first I/O interface 170, the image sensing device of the host device 100 will be referred to as a first image sensing device 110, the line memory of the host device 100 will be referred to as a first line memory 122, and the ISP of the host device 100 will be referred to as a first ISP 123. The first line memory 122 and the first ISP 123 illustrated in FIG. 3 will be referred to as a first logic unit 120.

Each of the first image sensing device 150 and the second image sensing device 250 may be or include a CIS (Complementary Metal Oxide Semiconductor Image Sensor) configured to convert an optical signal into an electric signal. The overall operations such as turning on/off, operation modes, operation timings, sensitivity, and/or others of the first image sensing device 150 and the second image sensing device 250 may be controlled by the main processors 130 and 230. The image sensing devices 150 and 250 may transmit image data obtained by converting the optical signal into the electric signal to the line memories 122 and 222 based on the control of the main processors 130 and 230.

The hall sensor 260 may serve to sense an attachment and a detachment of the attachable device 200 to and from the host device 100. When attachment of the attachable device 220 to the host device 100 is sensed by the hall sensor 260, the hall sensor 260 may control the second power unit 240 and turn off the second main processor 230. The detailed description regarding the above will be provided below. In the present disclosure, only the hall sensor 260 is taken as an example of a component configured to sense attachment and detachment of the attachable device 200 to and from the host device 100, but other implementations are also possible. Thus, in some implementations, other sensors than the hall sensor can be implemented to sense the attachment and the detachment of the attachable device 200.

When a smartphone is applied as the host device 100, the host device 100 may include the display panel 180. The display panel 180, can be implemented by utilizing various types of display panels such as the liquid crystal display panel or the organic light emitting display panel.

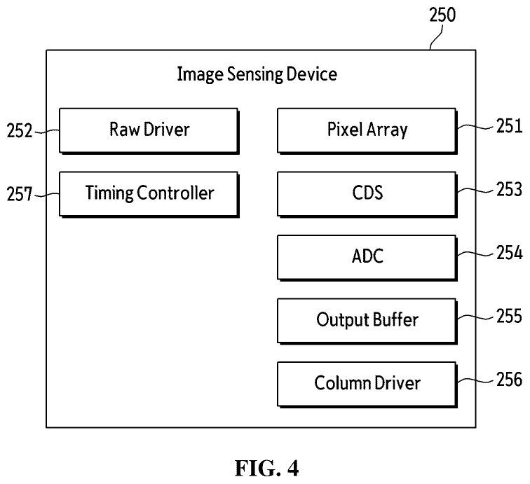

FIG. 4 is a diagram illustrating the second imaging device in FIG. 2 based on some implementations of the disclosed technology.

Referring to FIG. 4, the second image sensing device 250 may include a pixel array 251, a row driver 252, a CDS 253 (Correlate Double Sampler), an ADC 254 (Analog-Digital Converter), an output buffer 255, a column driver 256, and a timing controller 257. The components of the second image sensing device 250 are discussed by way of example only, and at least some components may be added or omitted according to necessities. Components of the first image sensing device 210 are substantially the same as those of the second image sensing device 250, therefore, redundant description will be omitted.

The pixel array 251 may include a plurality of imaging pixels arranged in a plurality of rows and a plurality of columns. In the embodiment, the plurality of imaging pixels can be arranged in a two dimensional pixel array including rows and columns. In another example, the plurality of imaging pixels can be arranged in a three dimensional pixel array. The plurality of imaging pixels may convert an optical signal into an electrical signal on a unit pixel basis or a pixel group basis, where the imaging pixels in a pixel group share at least a certain internal circuitry. The pixel array 251 may receive pixel control signals, including a row selection signal, a pixel reset signal and a transmission signal, from the row driver 252. Upon receiving the pixel control signals, corresponding pixels in the pixel array 251 may be activated to perform the operations corresponding to the row selection signal, the pixel reset signal, and the transmission signal. Each of the imaging pixels may generate photocharges corresponding to the intensity of incident light (or luminous intensity), may generate an electrical signal corresponding to the amount of photocharges, thereby sensing the incident light. For convenience of description, the imaging pixel may also be referred to as a pixel.

The row driver 252 may activate the pixel array 251 to perform certain operations on the imaging pixels in the corresponding row based on commands and control signals provided by the timing controller 257. In the embodiment, the row driver 252 may select at least one pixel arranged in at least one row of the pixel array 251. The row driver 252 may generate a row selection signal to select at least one row among the plurality of rows. The row driver 252 may sequentially enable the pixel reset signal and the transmission signal for the pixels corresponding to at least one selected row. Thus, a reference signal and an image signal, which are analog signals generated by each of the pixels of the selected row, may be sequentially transferred to the CDS 253.

The CDS 253 may sequentially sample and hold the reference signal and the image signal, which are provided to each of a plurality of column lines from the pixel array 251. The CDS 253 may transfer the reference signal and the image signal of each of the columns as a correlate double sampling signal to the ADC 254 based on control signals from the timing controller 257.

The ADC 254 may convert analog CDS signals output from the CDS 253 with respect to each column into digital signals, and output image data.

The output buffer 255 may temporarily hold the column-based image data provided from the ADC 254 to output the image data. The output buffer 255 may temporarily store image data output from the ADC 254 based on the control signal of the timing controller 257.

The column driver 256 may select a column of the output buffer 255 based on a control signal from the timing controller 257, and sequentially output the image data, which are temporarily stored in the selected column of the output buffer 255.

The timing controller 257 may control at least one among the row driver 250, the CDS 253, the ADC 254, the output buffer 255 and the column driver 256.

The timing controller 257 may provide at least one among the row driver 252, the CDS 253, the ADC 254, the output buffer 255 and the column driver 256 with a clock signal required for the operations of the respective components of the image sensing device 100, a control signal for timing control, and address signals for selecting a row or column.

Referring back to FIGS. 2 and 3, the line memories 122 and 222 may include a volatile memory (e.g., DRAM, SRAM, etc.) and/or a non-volatile memory (e.g., a flash memory). The line memories 122 and 222 may have a capacity capable of storing image data corresponding to a predetermined number of lines.

The line memories 122 and 222 may receive image data from the image sensing devices 150 and 250, may store the received image data, and may transmit the stored image data to the ISPs 123 and 223 based on the control of the ISPs 123 and 223.

The ISPs 123 and 223 may perform image processing of the image data stored in the line memories 122 and 222. The ISPs 123 and 223 may reduce noise of image data, and may perform various kinds of image signal processing such as gamma correction, color filter array interpolation, color matrix, color correction, color enhancement, lens distortion correction, etc. for image-quality improvement of the image data. In addition, the ISPs 123 and 223 may compress image data that has been created by execution of image signal processing for image-quality improvement, such that the ISPs 123 and 223 can create an image file using the compressed image data. Alternatively, the ISPs 123 and 223 may recover image data from the image file. In this case, the scheme for compressing such image data may be a reversible format or an irreversible format. As a representative example of such compression format, in the case of using a still image, Joint Photographic Experts Group (JPEG) format, JPEG 2000 format, or the like can be used. In addition, in the case of using moving images, a plurality of frames can be compressed according to Moving Picture Experts Group (MPEG) standards such that moving image files can be created. For example, the image files may be created according to Exchangeable image file format (Exif) standards.

In order to generate the HDR image, the ISPs 123 and 223 may include a gain processing unit, and an image compositing unit.

The gain processing unit may determine a gain to be calculated with (to be multiplied by) image data.

The image compositing unit may synthesize HDR image corresponding to a high dynamic range by using the image data of the pixel operating in the HCG mode and/or the image data of the pixel operating in the LCG mode.

According to the embodiment, the image compositing unit may perform a calculation, using the gain provided from the gain processing unit, on the image data of the pixel operating in the HCG mode and/or the image data of the other pixel operating in the LCG mode, and may allow the calculated image data to be formed as the HDR image.

The ISPs 123 and 223 may transmit image data (e.g., HDR image data) obtained by such image signal processing to the I/O interfaces 170 and 270.

The I/O interfaces 170 and 270 may perform a communication with an attachable device. The I/O interfaces 170 and 270 may include a wireless interface such as a mobile industry processor interface (MIPI), BLE, or WiFi, but the embodiment of the present disclosure is not limited thereto. Each of the I/O interfaces 170 and 270 may serve to perform wireless communication between the attachable device 200 and the host device 100.

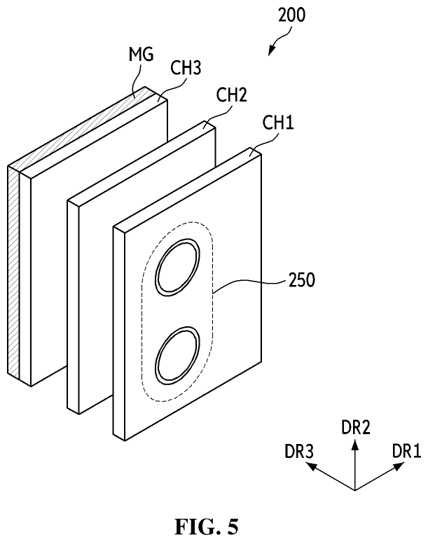

FIG. 5 is a perspective view of the attachable device according to an embodiment.

Referring to FIG. 5, the attachable device 200 may include a first chip CH1, a second chip CH2 disposed below the first chip CH1, and a third chip CH3 below the second chip CH2. On the lowest surface of the attachable device 200, a magnet part MG may be disposed. The term, “below,” has been used to describe the relative positions of the first chip CH1, the second chip CH2, the third chip CH3, and the magnet part MG, and such relative positions may be described using other terms depending on the viewpoint. With the inclusion of the magnetic part MG, the attachable device 200 may be easily attached to a rear surface of the host device 100. Each of the first chip CH1, the second chip CH2, and the third chip CH3 is configured as a separate chip, and the first chip CH1 may include the second image sensing device 250. The second chip CH2 may include the second logic unit 220 in FIG. 2. The third chip CH3 may include the hall sensor 260 in FIG. 2. The second chip CH2 may further include the second main processor 230, the second power unit 240, and the second I/O interface 270, but the embodiments of the present disclosure are not limited thereto.

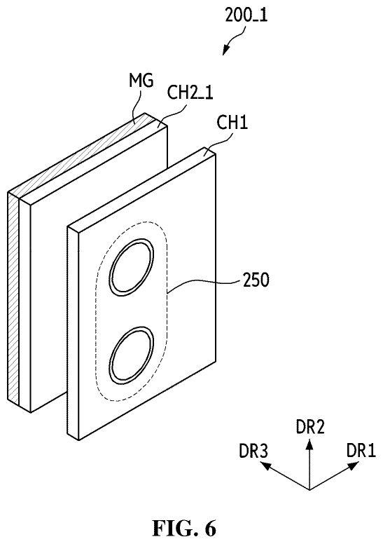

FIG. 6 is a perspective view of an attachable device based on some implementations of the disclosed technology.

An attachable device 200_1 as shown in FIG. 6 is different from the attachable device 200 as shown in FIG. 5 in that a second chip CH2_1 includes the second logic unit 220 in FIG. 2, and the hall sensor 260 in FIG. 2.

According to the present embodiment, there is an effect that the attachable device 200_1 may become slimmer because the hall sensor 260 is integrated into the second chip CH2_1.

Hereinafter, a method for operating the imaging system according to the embodiment described referring to FIGS. 1 to 4 will be described. The method described below can be applied to the imaging system as shown in FIGS. 1 to 4 and thus FIGS. 1 to 4 will be referred in the description below.

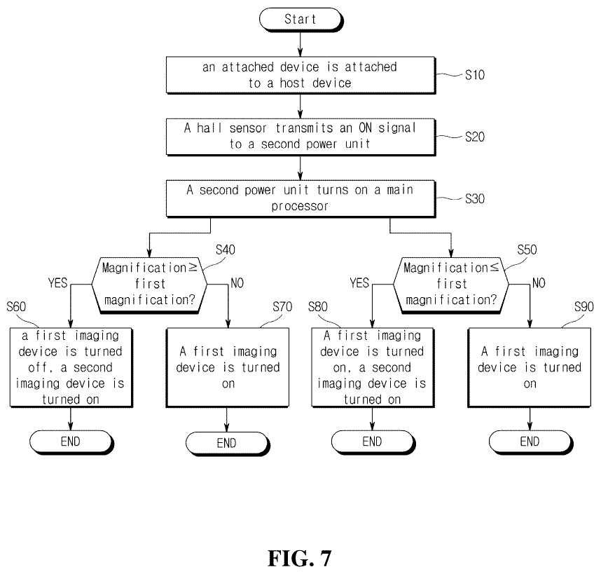

FIG. 7 is a flowchart illustrating a method for operating the imaging device according to an embodiment.

Referring to FIGS. 1 to 4, and FIG. 7, the method for operating the imaging system according to an embodiment includes detecting of an attachment of an attachable device 200 to a host device 100 (S10). The detecting of the attachment of the attachable device 200 to a host device 100 (S10) may include sensing, by the attachable device 200, of the attachment of the attachable device 200 to the host device 100 through the hall sensor 260. As described above, in some implementations, the attachable device 200 may sense the attachment to the host device 100 through various sensors other than the hall sensor 260.

After the attachable device 200 is attached to the host device 100 (S10), the hall sensor 260 transmits an ON signal to the second power unit 240 (S20). In this operation (S20), the hall sensor 260 may control the second power unit 240.

After the hall sensor 260 transmits an ON signal to the second power unit 240 (S20), the second power unit 240 turns on the second main processor 230 (S30). In this operation (S30), the second main processor 230 of the attachable device 200 is turned on, however the second image sensing device 200 may have been turned off. In some embodiments, in the present operation (S30), the second image sensing device 250 may be turned on, however, the second image sensing device 250 may be in a state in which the voltage for generating image data (or image) is not supplied. In this case, the photography application based on the first imaging device 110 may be operated through the host device 100. When the attachable device 200 is attached to the host device 100, the photography application of the host device 100 may be operated. When pressing a photographing button in the photography application, image data is generated and processed, and a final image data can be generated by the first imaging device 110. When photographing an object with the photography application, an image of the object is viewed in a screen of the display panel 180 of the host device 100 by the first imaging device 110, and a user of the host device 100 photographs the object by using the image of the object viewed in the screen, and a function of zooming or adjusting brightness of the photography application. The second image sensing device 250 may have been turned on in a state in which the voltage for generating image data (or image) is not supplied to the second image sensing device 250. Such state in which the voltage for generating image data (or image) is not supplied to the second image sensing device 250 may mean that an image of an object viewed in a screen when the user starts using the photography application is generated only by the first imaging device 100. In this case, when the user photographs the object, the final generated image data may be the one generated only by the first imaging device 110.

In some implementations, when photographing an image using the photography application of the host device 100, the first imaging device 110 and/or the second imaging device 210 may be applied differently according to the magnification (S40 and S50). The operation of applying the first imaging device 110 and/or the second imaging device 210 differently according to the magnification (S40 and S50) when photographing an image using the photography application of the host device 100 may be divided according to the magnification (or zoom) or the photography application.

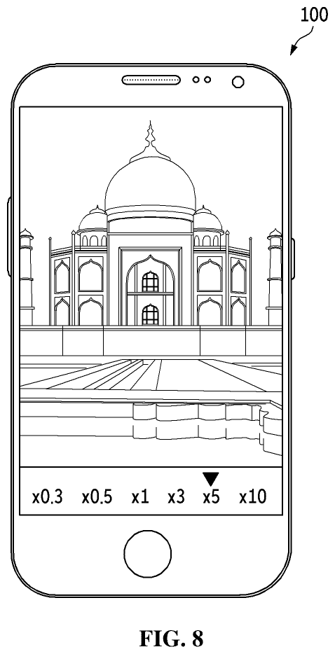

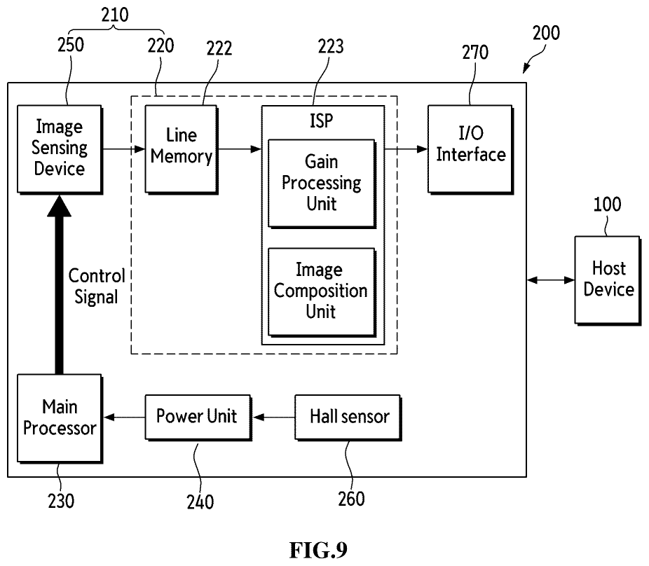

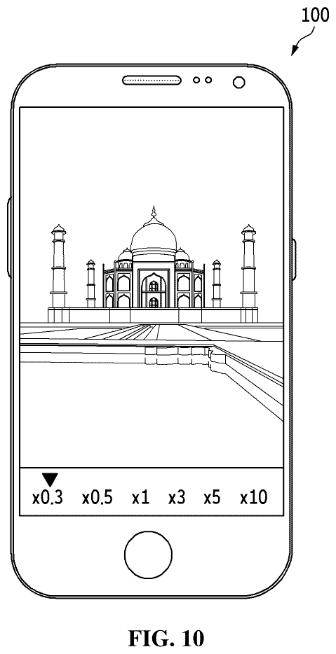

FIG. 8 is a view illustrating an example in which a high magnification is applied to the photography application of the host device. FIG. 9 is a diagram illustrating an operation of the second imaging device when a high magnification is applied. FIG. 10 is a view illustrating an example in which a low magnification is applied to the photography application of the host device.

Referring to FIGS. 1 to 4, and FIGS. 7 and 8, for the photography application, various magnifications can be applied, which include, for example, a first magnification, a second magnification greater than the first magnification, or others. For example, the second magnification may be a relatively high magnification, and the first magnification may be a relatively low magnification. For example, the high magnification may mean the magnification that is 5 times or more, however, the embodiments of the present disclosure are not limited thereto. For example, low magnification may be the magnification that is 0.3 times or less, however, the embodiments of the present disclosure are not limited thereto.

As illustrated in FIG. 8, when the second magnification or more is applied as the magnification (S40), the second imaging device 210 is turned on, and the first imaging device 110 is turned off (S60). Since the second imaging device 210 is turned on and the first imaging device 110 is turned off (S60), an image of an object viewed in a screen when the user starts using the photography application is generated only by the second imaging device 210. In this case, when the user photographs the object, the final generated image data may be the one generated only by the second imaging device 210. Thus, when intending to generate an image of a high magnification, the high performance second imaging device 210 is turned on, and the first imaging device 110 having low performance, compared to the second imaging device 210, is turned off. Therefore, a final image may be generated through the second imaging device 210. In the operation in which the second imaging device 210 is turned on and the first imaging device 110 is turned off (S60), as illustrated in FIG. 9, the second main processor 230 transmits a control signal to the second image sensing device 250 to operate the second image sensing device 250. The control signal transmitted to the second image sensing device 250 may include not only commands and control signals transmitted to the timing controller 257, but also a voltage applied to the pixel array 251.

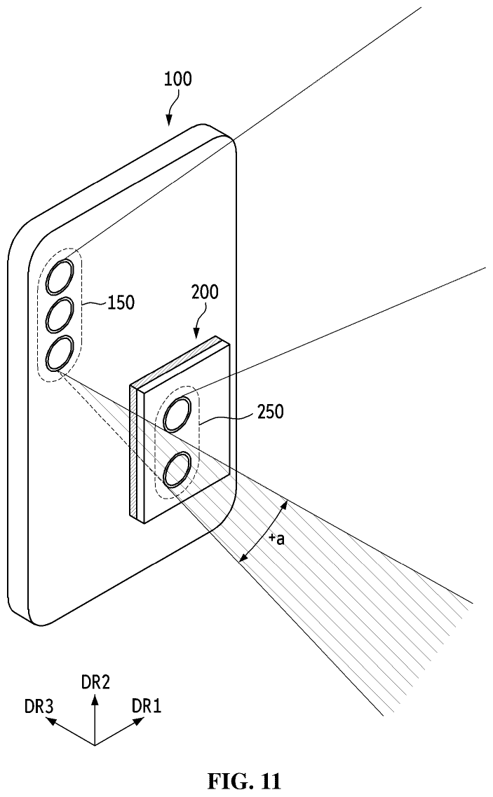

As illustrated in FIG. 10, when the first magnification or the less is applied as the magnification (S50), the first imaging device 110 and the second imaging device 210 both may be turned on (S80). Since the first imaging device 110 and the second imaging device 210 both are turned on (S80), an image of an object viewed in a screen when the user starts using the photography application is generated by the first imaging device 110 and the second imaging device 210. In this case, when the user photographs the object, the final generated image data may be the one generated by the first imaging device 110 and the second imaging device 210. Generation of the final image data in an example in which the first magnification or the less is applied as the magnification (S50) will be described below with reference to FIG. 11. As illustrated in FIG. 11, when the first magnification or the less is applied as the magnification (S50), the final image data is generated by the first imaging device 110 and the second imaging device 210 that are disposed at different positions from each other, and thus, there is an effect that the angle of view is widened (the angle of view is widened by as much as ‘a’ compared to the existing angle of view, ‘a’ is a real number which is greater than 0).

When a magnification smaller the first magnification and greater than the second magnification is applied as the magnification (S70 and S80), the first imaging device 110 may be turned on and the second imaging device 210 may be turned off, which means that an image of an object viewed in a screen when the user starts using the photography application is generated by the first imaging device 110. In this case, when the user photographs the object, the final generated image data may be the one generated by the first imaging device 110 only.

Hereinafter, a process for processing images generated by the first imaging sensing device 150 and the second image sensing device 250 will be described.

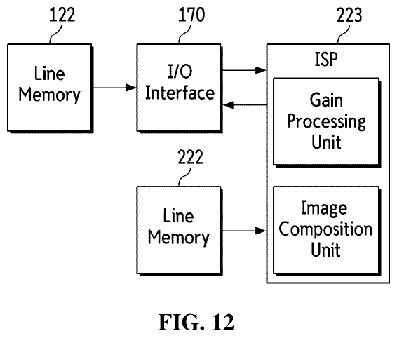

FIG. 12 is a diagram illustrating a process for processing an image generated by the first imaging sensing device and an image generated by the second image sensing device of the imaging system based on some implementations of the disclosed technology.

The description below referring to FIG. 12 mainly relates to a process for processing an image generated by the first imaging sensing device 150 and an image generated by the second image sensing device 250 in case the first magnification or the less is applied as the magnification as in FIG. 7.

Referring to FIGS. 2, 3, and 12, the first line memory 122 of the imaging system according to the embodiment may transmit image data generated by the first image sensing device 150 to the first I/O interface 170. Like operations S70 and S90 in FIG. 7, when generating image data only with the first imaging device 110, the first line memory 122 transmits image data to the first ISP 123. When processing image data generated by each of the first image sensing device 150 and the second image sensing device 250, image data may be processed using the second ISP 223, which has higher specification than that of the first ISP 123. Therefore, the first I/O interface 170 transmits image data generated by the first image sensing device 150 to the second ISP 223, and the second line memory 222 transmits image data generated by the second image sensing device 250 to the second ISP 223. The second ISP 223 processes image data generated by the first image sensing device 150 and image data generated by the second image sensing device 250, and generates the final image data.

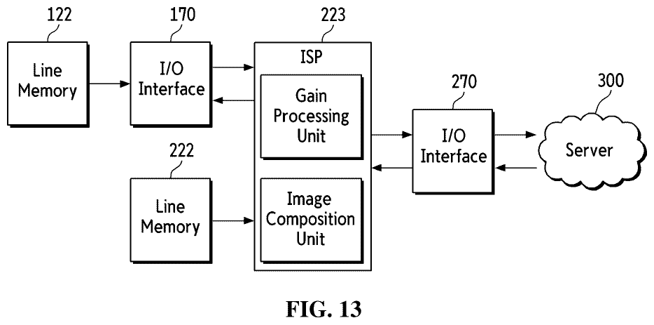

FIG. 13 is a diagram illustrating a process for processing an image generated by the first imaging sensing device and an image generated by the second image sensing device of the imaging system based on some implementations of the disclosed technology.

According to the imaging system in FIG. 13, the second ISP 223 transmits image data provided from the first and the second image sensing devices 150 and 250 to the server using the second I/O interface 270. The server 300 processes image data provided from the first and the second image sensing devices 150 and 250, generates the final image data, and transmits the final image data to the second ISP 223 using the second I/O interface 270 again. According to the present embodiment, the server 300 processes image data provided from the first image sensing device 150 and image data provided from the second image sensing device 250, there is an effect that load of the second ISP 223 may be reduced.

In some embodiments, image data generated in the operations at S70 and S90 in FIG. 7 may be processed by the server 300, rather than the first ISP 123, however, the embodiments of the present disclosure are not limited thereto.

In some embodiments, image data generated in the operation of S60 in FIG. 7 may be processed by the server 300, rather than the second ISP 223, however, the embodiments of the present disclosure are not limited thereto.

Hereinafter, a manner of supplying power (or a manner of sharing a battery) between the host device (refer to 100 in FIG. 1) and the attachable device (refer to 200 in FIG. 1) will be described.

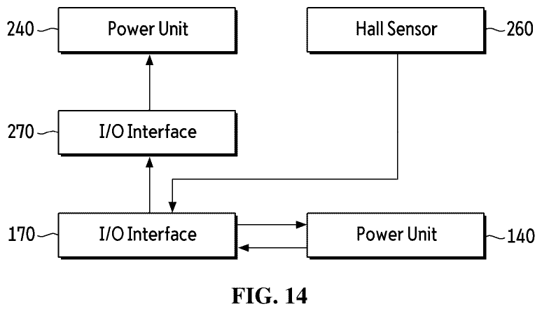

FIG. 14 is a diagram illustrating supply of power between the host device and the attachable device of the imaging system according to an embodiment.

Referring to FIGS. 2, 3, and 14, when the hall sensor 260 of the imaging system according to an embodiment determines that the attachable device 200 is attached to the host device 100, the hall sensor 260 may transmit a control signal to the first I/O interface 170. In some embodiments, when the hall sensor 260 determines that the attachable device 200 is attached to the host device 100, the second I/O interface 270 may transmit a control signal to the first I/O interface 170, rather than that the hall sensor 260 directly transmits the control signal to the first I/O interface 170. When the first I/O interface 170 receives the control signal from the hall sensor 260, the first I/O interface 170 controls the first power unit 140 to transfer power to the second power unit 240. A manner of supplying power of the first power unit 140 to the second power unit 240 may be the wireless power supply (or wireless battery supply) through the I/O interfaces 170 and 270 as illustrated in FIG. 14, however, the embodiments of the present disclosure are not limited thereto.

In some embodiments, the second power unit 240 may be self-supplied with power from an external power supply instead of receiving power from the first power unit 140. However, other implementations are also possible without being limited thereto.

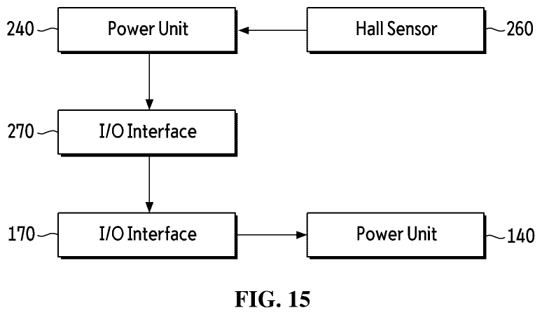

FIG. 15 is a diagram illustrating supply of power between the host device and the attachable device of the imaging system according to another embodiment.

Referring to FIG. 15, according to the imaging system according to the present embodiment, when the hall sensor 260 determines that the attachable device 200 is attached to the host device 100, the hall sensor 260 may transmit a control signal to the second power unit 240. In some embodiments, when the hall sensor 260 determines that the attachable device 200 is attached to the host device 100, the second I/O interface 270 may transmit a control signal to the second power unit 240, rather than that the hall sensor 260 directly transmits the control signal to the second power unit 240. When the second power unit 240 receives the control signal from the hall sensor 260, power may be supplied to the first power unit 140 through the I/O interfaces 170 and 270. A manner of supplying power of the second power unit 240 to the first power unit 140 may be the wireless power supply through the I/O interfaces 170 and 270 as illustrated in FIG. 15, however, the embodiments of the present disclosure are not limited thereto.

Hereinafter, an imaging system to which the attachable device 200_1 in a three-dimensional image generation method is applied will be described.

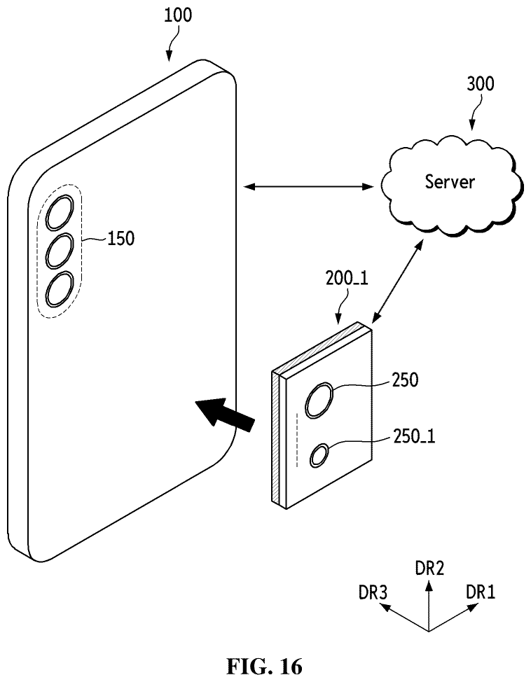

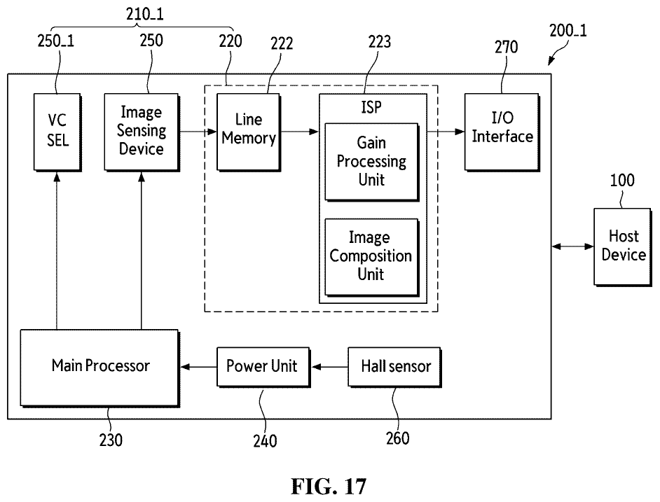

FIG. 16 is a block diagram illustrating an imaging system according to another embodiment. FIG. 17 is a diagram illustrating the attachable device in FIG. 16 in greater detail.

Referring to FIG. 16, the imaging system according to the present embodiment may include the host device 100, the attachable device 200_1, and the server 300. The host device 100 may include the first image sensing device 150. The attachable device 200 may include the second image sensing device 250, and a light emitting unit 250_1. The second image sensing device 250 may be provided in plural numbers, however, the embodiments of the present disclosure are not limited thereto.

Each of the first imaging device and the second imaging device may include a device capable of photographing an object and generating an image because both include a lens and an imaging element, respectively. For example, the first image sensing device of the first imaging device receives visible light and generates image (or image data), and the second image sensing device of the second imaging device receives infrared light (or near-infrared light) and generates image (or image data). The second imaging device 200_1 may further include the light emitting unit 250_1. The light emitting unit 250_1 may be a VCSEL (Vertical cavity surface emitting laser), however, the embodiments of the present disclosure are not limited thereto. The light emitting unit 250_1 may emit infrared light (or near-infrared light) to an object. The second image sensing device 250 may serve to receive reflected light which has been emitted by the light emitting unit 250_1 to the object and then, reflected from the object. The light emitting unit 250_1 may emit infrared light (or near-infrared light) in the form of a laser to an object.

The method for operating the imaging system according to the present embodiment will be described referring to FIGS. 7 and 17, while focusing on differences from the method for operating the imaging system as described with reference to FIG. 7.

The method for operating the imaging system according to the present embodiment includes attaching the attachable device 200_1 to the host device (S10). The description thereof has been provided referring to FIG. 7, therefore, detailed description will be omitted.

After the attaching the attachable device 200_1 to the host device (S10), the hall sensor 260 transmits an ON signal to the second power unit 240 (S20). In this operation (S20), the hall sensor 260 may control the second power unit 240.

After the hall sensor 260 transmits an ON signal to the second power unit 240 (S20), the second power unit 240 turns on the second main processor 230 (S30). After the second power unit 240 turns on the second main processor 230 (S30), the second main processor 230 may turn on the second image sensing device 250 and the light emitting unit 250_1.

In some implementations, the photography application based on the first imaging device 110 may be operated through the host device 100. When pressing a photographing button in the photography application, image data is generated and processed, and a final image data can be generated by the first imaging device 110 and a second imaging device 210_1. When photographing an object with the photography application, an image of the object viewed in a screen may be generated by the first imaging device 110 and the second imaging device 210_1. In this case, when the user photographs the object, the final generated image data may be the one generated by the first imaging device 110 and the second imaging device 210_1. The first imaging device 110 receives visible light and generates image data, and the second imaging device 210_1 includes the light emitting unit 250_1 and the second image sensing device 250, receives some of light reflected from the light emitted to the object by the light emitting unit 250_1 and generates image data (or distance data). When the light emitting unit 250_1 includes a VCSEL (Vertical cavity surface emitting laser), the image data generated by the second imaging device 210_1 may express distance information of the object in shapes of dots. In this case, because the image data generated by the second imaging device 210_1 expresses distance information of the object in shapes of dots, it may be difficult to precisely distinguish a shape of the object. (the resolution may be low) However, as described above, because the final image data is generated by the first imaging device 110 and the second imaging device 210_1, there is an effect that distance information of the final image data as well as the resolution can be sufficiently secured.

The imaging system according to various embodiments of the present disclosure may be described as below.

In one aspect, an imaging system is provided to comprise: a host device comprising a first imaging device; and an attachable device provided to be attachable to or detachable from the host device and comprising a second imaging device, wherein the attachable device further comprises: a first chip comprising a second image sensing device of the second imaging device; and a sensor configured to sense an attachment and a detachment of the attachable device with respect to the host device.

In some implementations, the attachable device further comprises a second chip comprising a logic circuit of the second imaging device, the logic circuit configured to drive the second image sensing device, and

In some implementations, the attachable device further comprises: a second chip comprising a logic circuit of the second imaging device, the logic circuit configured to drive the second image sensing device; and a third chip including the sensor.

In some implementations, the attachable device further comprises a magnet configured to be attachable to and detachable from the host device.

In some implementations, the first chip further comprises a light emitting unit configured to emit a near-infrared light, and the second image sensing device is configured to receive the near-infrared light reflected from an object.

In some implementations, the host device comprises a first power supply, and the attachable device comprises a second power supply, and the second power supply is configured to receive power from the first power supply.

In some implementations, the second power supply is configured to receive wirelessly power from the first power supply.

In some implementations, the second power supply is configured to receive power from the first power supply in response to detecting of the attachment of the attachable device to the host device.

In some implementations, the attachable device further comprises a first I/O (input/output) interface through which the attachable device communicates wirelessly with the host device, the host device further comprises a second I/O interface through which the host device communicates wirelessly with the attachable device, and in response to detecting of the attachment of the attachable device to the host device, a photography application of the host device operates.

In another aspect, a method for operating an imaging system is provided. The method comprises: detecting of an attachment of an attachable device comprising a second imaging device to a host device comprising a first imaging device; in response to the detecting of the attachment of the attachable device to the host device, allowing a second power supply of the attachable device to receive a turn-on signal and allowing the second power supply to turn on a second main processor of the attachable device; and operating at least one of the first imaging device or the second imaging device based on a magnification for capturing an image.

In some implementations, the detecting of the attachment of the attachable device includes sensing the attachment using a hall sensor.

In some implementations, for a first magnification or less, both of the first imaging device and the second imaging device are configured to operate to generate image data.

In some implementations, the image data generated by the first imaging device is transmitted to an image signal processor of the second imaging device, and the image signal processor of the second imaging device is configured to process the image data generated by the first imaging device and the image data generated by the second imaging device.

In some implementations, the image data generated by the first imaging device is transmitted to the image signal processor of the second imaging device, and the second imaging device is configured to transmit the image data generated by the first imaging device and the image data generated by the second imaging device to a server.

In some implementations, for a second magnification or more, the second imaging device is configured to generate image data and the first imaging device is not operable to generate the image data.

In some implementations, in case of a magnification greater than the second magnification and smaller than the first magnification, the first imaging device is configured to generate image data and the second imaging device is not operable to generate image data.

In some implementations, the first imaging device is configured to receive power from the second imaging device in response to the detecting of the attachment of the attachable device to the host device comprising the first imaging device.

In some implementations, the first imaging device is configured to receive wirelessly power from the second imaging device.

In some implementations, the attachable device is configured to receive power from the host device in response to detecting of the attachment of the attachable device to the host device comprising the first imaging device.

In another aspect, a method for operating an imaging system is provided. The method comprises: detecting of an attachment of an attachable device comprising a second imaging device to a host device comprising a first imaging device; and capturing an image using both of the first imaging device and the second imaging device, wherein the first imaging device comprises a first image sensing device configured to receive visible light, and wherein the second imaging device comprises a light emitting unit configured to emit a near-infrared light, and a second image sensing device configured to receive reflected light which is the near-infrared light emitted from the light emitting unit and reflected from an object.

In some implementations, the detecting of the attachment of the attachable device includes sensing the attachment using a hall sensor.

The embodiments of the present disclosure have been described with reference to the accompanying drawings. Only a few implementations and examples are described and other implementations, enhancements and variations can be made based on what is described and illustrated in this patent document.

1. An imaging system, comprising:
a host device comprising a first imaging device; and
an attachable device provided to be attachable to or detachable from the host device and comprising a second imaging device,
wherein the attachable device further comprises:
a first chip comprising a second image sensing device of the second imaging device; and
a sensor configured to sense an attachment and a detachment of the attachable device with respect to the host device.

2. The imaging system of claim 1,
wherein the attachable device further comprises a second chip comprising a logic circuit of the second imaging device, the logic circuit configured to drive the second image sensing device, and
wherein the sensor is included in the second chip.

3. The imaging system of claim 1,
wherein the attachable device further comprises: a second chip comprising a logic circuit of the second imaging device, the logic circuit configured to drive the second image sensing device; and a third chip including the sensor.

4. The imaging system of claim 1,
wherein the attachable device further comprises a magnet configured to be attachable to and detachable from the host device.

5. The imaging system of claim 1,
wherein the first chip further comprises a light emitting unit configured to emit a near-infrared light, and
wherein the second image sensing device is configured to receive the near-infrared light reflected from an object.

6. The imaging system of claim 1,
wherein the host device comprises a first power supply, and the attachable device comprises a second power supply, and
wherein the second power supply is configured to receive power from the first power supply.

7. The imaging system of claim 6,
wherein the second power supply is configured to receive wirelessly power from the first power supply.

8. The imaging system of claim 6,
wherein the second power supply is configured to receive power from the first power supply in response to detecting of the attachment of the attachable device to the host device.

9. The imaging system of claim 1,
wherein the attachable device further comprises a first I/O (input/output) interface through which the attachable device communicates wirelessly with the host device,
wherein the host device further comprises a second I/O interface through which the host device communicates wirelessly with the attachable device, and
wherein in response to detecting of the attachment of the attachable device to the host device, a photography application of the host device operates.

10. A method for operating an imaging system, comprising:
detecting of an attachment of an attachable device comprising a second imaging device to a host device comprising a first imaging device;
in response to the detecting of the attachment of the attachable device to the host device, allowing a second power supply of the attachable device to receive a turn-on signal and allowing the second power supply to turn on a second main processor of the attachable device; and
operating at least one of the first imaging device or the second imaging device based on a magnification for capturing an image.

11. The method of claim 10,
wherein the detecting of the attachment of the attachable device includes sensing the attachment using a hall sensor.

12. The method of claim 10,
wherein, for a first magnification or less, both of the first imaging device and the second imaging device are configured to operate to generate image data.

13. The method of claim 12,
wherein the image data generated by the first imaging device is transmitted to an image signal processor of the second imaging device, and
wherein the image signal processor of the second imaging device is configured to process the image data generated by the first imaging device and the image data generated by the second imaging device.

14. The method of claim 13,
wherein the image data generated by the first imaging device is transmitted to the image signal processor of the second imaging device, and
wherein the second imaging device is configured to transmit the image data generated by the first imaging device and the image data generated by the second imaging device to a server.

15. The method of claim 10,
wherein, for a second magnification or more, the second imaging device is configured to generate image data and the first imaging device is not operable to generate the image data.

16. The method of claim 15,
wherein in case of a magnification greater than the second magnification and smaller than the first magnification, the first imaging device is configured to generate image data and the second imaging device is not operable to generate image data.

17. The method of claim 10,
wherein the first imaging device is configured to receive power from the second imaging device in response to the detecting of the attachment of the attachable device to the host device comprising the first imaging device.

18. The method of claim 17,
wherein the first imaging device is configured to receive wirelessly power from the second imaging device.

19. The method of claim 17,
wherein the attachable device is configured to receive power from the host device in response to detecting of the attachment of the attachable device to the host device comprising the first imaging device.

20. A method for operating an imaging system, comprising:
detecting of an attachment of an attachable device comprising a second imaging device to a host device comprising a first imaging device; and
capturing an image using both of the first imaging device and the second imaging device,
wherein the first imaging device comprises a first image sensing device configured to receive visible light, and
wherein the second imaging device comprises a light emitting unit configured to emit a near-infrared light, and a second image sensing device configured to receive reflected light which is the near-infrared light emitted from the light emitting unit and reflected from an object.
